(19) United States
(12) Patent Application Publication
(10) Pub. No.: US 2020/0043430 A1
(43) Pub. Date: Feb. 6, 2020

(54) DISPLAY PANEL AND METHOD FOR DRIVING DISPLAY PANEL

(71) Applicant: SAKAI DISPLAY PRODUCTS CORPORATION, Osaka (JP)

(72) Inventor: YOSHIYUKI SHIMIZU, Osaka (JP)

(21) Appl. No.: 16/456,754

(22) Filed: Jun. 28, 2019

(30) Foreign Application Priority Data
Aug. 3, 2018 (JP) 2018-146956

(51) Int. Cl. G09G 3/36; H02H 7/20; H02H 1/00

(52) U.S. Cl. CPC G09G 3/3648; H02H 7/205; G09G 2330/045; G09G 2300/0408; H02H 1/0007

(57) ABSTRACT

A display panel according to an embodiment of the present invention includes at least one driver integrally formed in a surrounding region, a plurality of monitor TFTs formed near the at least one driver, and including a. first TFT and a second TFT, and a temperature difference detection. circuit for detecting a difference between a temperature of the first TFT and a temperature of the second TFT, the basis of a first gate voltage of the first TFT and a second gate voltage of the second TFT that occur when a predetermined current is supplied to a drain of each of the first and second TFTs. The temperature difference detection. circuit may detect a difference between a temperature of the first TFT and a temperature of the second TFT, on the basis of a first drain current of the first TFT and a second drain. current of the second TFT that occur when a predetermined direct-current voltage is supplied to a gate of each of the first and second TFTs.

### BACKGROUND

### 1. Technical Field

The present invention relates to an active-matrix display panel (e.g., a liquid crystal display panel or an organic EL display panel) and a drive method therefor, and more particularly, to a driver-monolithic display panel in which a driver is integrally formed with a display panel, and a drive method therefor.

### 2. Description of the Related Art

An active-matrix display panel typically has a plurality of pixels arranged in a matrix. For each pixel, provided is at least one thin-film transistor (hereinafter referred to a “TFT”). For example, in an active-matrix liquid-crystal display panel, each pixel has a pixel electrode, and a common electrode (also referred to as a “counter electrode”) located facing the pixel electrode with a liquid crystal layer interposed therebetween. The pixel electrode is electrically connected to the drain electrode of the TFT provided for that pixel. The gate electrode of the TFT is electrically connected to a gate line (also referred to as a “scanning line”) . The “on” and “off” of the TFT is controlled according to a gate signal (also referred to as a “scanning signal”) supplied from a gate driver. The source electrode of the TFT is connected to a source line (also referred to as a “signal line”), to which a source signal (also referred to as a “display signal”) is supplied from a source driver.

In a typical liquid crystal display panel, a liquid crystal layer is sandwiched between two transparent substrates (e.g., glass substrates). Pixel electrodes, TFTs, gate lines, and source lines are formed on a surface facing the liquid crystal layer of one of the transparent substrates. These elements as a whole are referred to as a “TFT substrate.” A common electrode, color filters, etc., are formed on a surface facing the liquid crystal layer of the other transparent substrate. These elements as a whole are referred to as a “counter substrate” or “color filter substrate.” Note that the common electrode may be provided in the TFT substrate. In a typical direct-view transparent liquid crystal display panel, the counter substrate is located closer to a viewer, and a backlight device is located behind the TFT substrate. In some organic EL display panels, the counter substrate is not required. In the liquid crystal display panel and the organic EL display panel, one or more polarizers are optionally provided. The structures of these display panels are well known and will not be described in detail.

The definition of liquid crystal display panels has been increasing, resulting in an increase in the load on the driver. This may cause heat generation in the driver, leading to a display defect. To address such a problem, for example, Japanese Laid-Open Patent Publication No. 2009-288668 discloses a method for driving a liquid crystal display panel, wherein the liquid crystal display panel is provided with a temperature sensor, and the liquid crystal display panel is driven in such a manner that reduces the load on the source driver when the ambient temperature of the liquid crystal display panel is high.

### SUMMARY

In driver-monolithic display panels, in which a driver is integrally formed with a display panel, in some cases, the driver is likely to be locally overheated due to heat generation of the driver, resulting in a malfunction of the driver. In liquid crystal display panels, in some cases, the liquid crystal material near the driver is likely to be heated to about or higher than the phase transition temperature, resulting in a failure to normally display. In organic EL display panels, a malfunction of the driver, and a display defect caused by heating of the organic EL material, are likely to occur in some cases. Note that these problems can occur in a display panel in which at least the gate driver or the source driver is integrated with the TFT substrate.

With the above circumstances in mind, the present invention has been made. It is an object of the present invention to provide a driver-monolithic active-matrix display panel in which an operational failure of the display panel is prevented by detecting local overheat of a driver in the display panel, and a drive method therefor.

A display panel according to an embodiment of the present invention having a display region, and a surrounding region surrounding the display region, the display panel including: at least one driver integrally formed in the surrounding region; a plurality of monitor TFTs formed near the at least one driver, and including a first TFT and a second TFT; and a temperature difference detection circuit for detecting a difference between a temperature of the first TFT and a temperature of the second TFT, on the basis of a first gate voltage of the first TFT and a second gate voltage of the second TFT that occur when a predetermined current is supplied to the drain of each of the first and second TFTs.

A display panel according to another embodiment of the present invention having a display region, and a surrounding region surrounding the display region, the display panel including: at least one driver integrally formed in the surrounding region; a plurality of monitor TFTs formed near the at least one driver, and including a first TFT and a second TFT; and a temperature difference detection circuit for detecting a difference between a temperature of the first TFT and a temperature of the second TFT, on the basis of a first drain current of the first TFT and a second drain current of the second TFT that occur when a predetermined direct-current voltage is supplied to the gate of each of the first and second TFTs.

A method for driving a display panel according to an embodiment of the present invention including: limiting drive of the at least one driver on the basis of an output result of the temperature difference detection circuit of the display panel set forth above. To limit drive of the driver means inhibiting heat generation of the driver in broad sense, and may include stopping drive of the driver or reducing the frequency of driving the driver.

According to the embodiments of the present invention, provided are: a driver-monolithic active-matrix display panel in which the operational failure of the display panel can be prevented by detecting local overheat of the display panel; and a drive method therefor.

### BRIEF DESCRIPTION OF THE DRAWINGS

FIG. 1 is a schematic diagram of a display apparatus in a first embodiment.

FIG. 2 is a block diagram showing a main configuration of a display panel.

FIG. 3 is a diagram for describing a control circuit and monitor circuits.

FIG. 4 is a diagram for describing a gate voltage value input to a control circuit.

FIG. 5 is a flowchart showing steps of a protection process.

FIG. 6 is a diagram showing a table indicating a relationship between gate voltage values and correcting voltage values.

FIG. 7 is a flowchart showing steps of a protection process in a second embodiment.

FIG. 8 is a diagram for describing a control circuit and monitor circuits in a third embodiment.

FIG. 9 is a diagram for describing a drain current value detected by a current sensor.

FIG. 10 is a flowchart showing steps of a protection process.

FIG. 11A is a diagram showing a table indicating a relationship between drain current values and correcting current values.

FIG. 11B is a diagram for describing a control circuit and monitor circuits in a variation of the third embodiment.

FIG. 12 is a flowchart showing steps of a protection process in a fourth embodiment.

FIG. 13 is a diagram for describing a control circuit and monitor circuits in a fifth embodiment.

FIG. 14 is a diagram for describing a gate voltage value input to a control circuit.

FIG. 15 is a diagram for describing a control circuit and monitor circuits in a sixth embodiment.

FIG. 16 is a diagram for describing a drain current value detected by a current sensor.

### DETAILED DESCRIPTION

The present invention will now be described with reference to the accompanying drawings showing embodiments thereof. Note that embodiments of the present invention are not limited to those illustrated below. For example, while a gate-driver-monolithic liquid-crystal display panel is illustrated below, the present invention is applicable to a source-driver-monolithic liquid-crystal display panel and an organic EL display panel. An embodiment of the present invention is applicable to a driver-monolithic display panel and a drive method therefor irrespective of display mode.

In a display panel according to an embodiment of the present invention, a plurality of monitor TFTs are formed near an integrally-formed (monolithically-formed) driver. The local overheat of the driver is detected on the basis of temperature-dependent changes in characteristics (e.g., gate voltage vs. drain current characteristics) of the monitor TFTs.

### First Embodiment

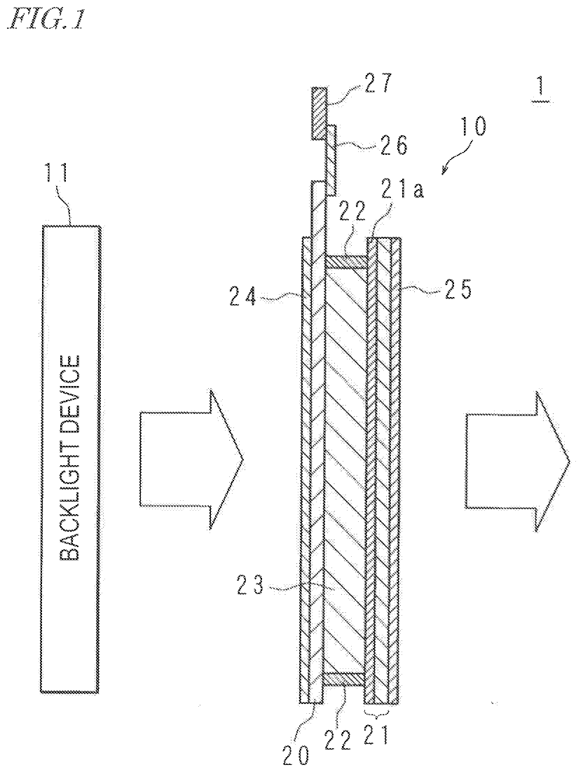

FIG. 1 is a schematic diagram of a display apparatus 1 in a first embodiment. The display apparatus 1 includes a display panel 10 and a backlight device 11. FIG. 1 shows a vertical cross-section of the display panel 10. The backlight device 11 emits light to the display panel 10. The display panel 10 displays an image using light emitted by the backlight device 11.

The display panel 10 has a TFT substrate 20, a color filter substrate (hereinafter referred to as a “CF substrate”) 21 located in front of the TFT substrate 20, and a liquid crystal layer 23 located between the TFT substrate 20 and the CF substrate 21. A sealing member 22 attaches the TFT substrate 20 and the CF substrate 21 to each other, and seals the liquid crystal layer 23. A plurality of pixel electrodes (not shown) included in the TFT substrate 20, and a common electrode 21a included in the CF substrate 21, are located facing each other with the liquid crystal layer 23 interposed therebetween.

A polarizer 24 is provided behind the TFT substrate 20. The front surface of the polarizer 24 faces the back surface of the TFT substrate 20. A polarizer 25 is provided in front of the CF substrate 21. The front surface of the CF substrate 21 faces the back surface of the polarizer 25. Light emitted from the backlight device 11 passes through the polarizer 24, the TFT substrate 20, the liquid crystal layer 23, the common electrode 21a, and the polarizer 25 in this order.

A lower portion of the printed circuit board 26 is connected to an upper portion of the TFT substrate 20. A lower portion of the control circuit board 27 is connected to an upper portion of the printed circuit board 26.

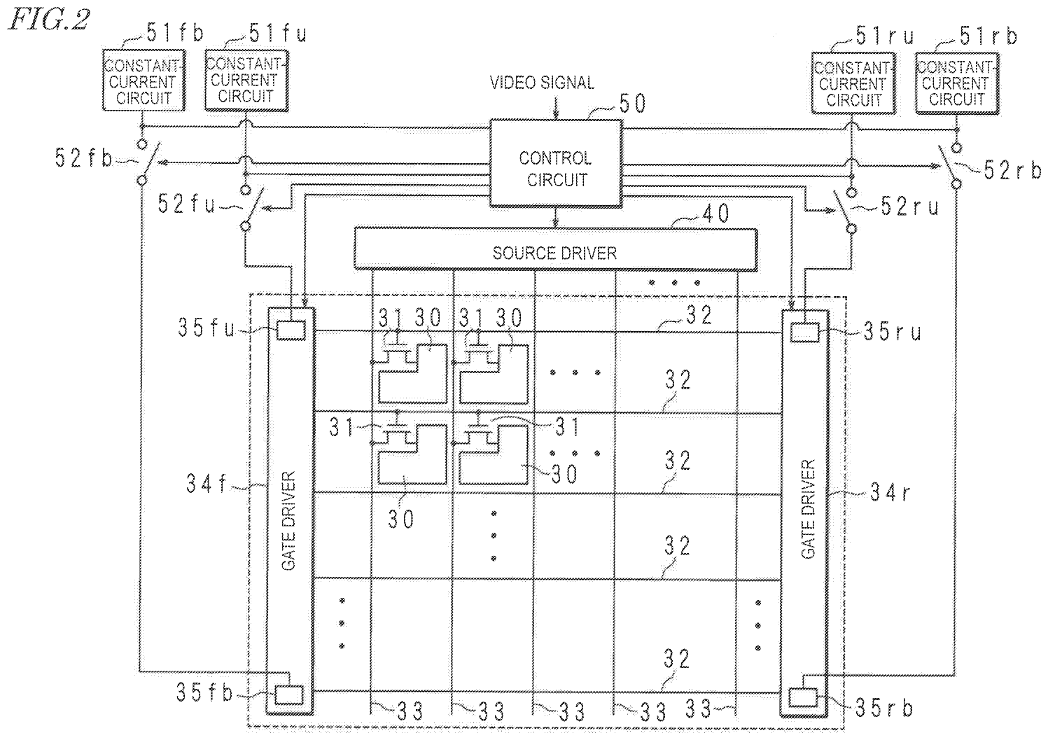

FIG. 2 is a block diagram showing a main configuration of the display panel 10. In FIG. 2, a portion surrounded by a dashed line indicates a configuration on the TFT substrate 20. Here, gate drivers 34r and 34f are integrally formed with the TFT substrate 20, and a source driver 40 is mounted on the printed circuit board 26 (see FIG. 1). The source driver 40 may be integrally formed on the TFT substrate 20.

Note that a region defined by a plurality of pixel electrodes 30, 30, . . . arranged in a matrix, in the TFT substrate 20 or the display panel 10, is referred to as a “display region,” and a region surrounding the display region is referred to as a “surrounding region.” The sealing member 22 is formed surrounding the display region, and the surrounding region of the TFT substrate 20 is exposed. The gate drivers 34r and 34f are formed in the surrounding region.

The display panel 10 has a plurality of TFTs 31, 31, . . . . The number of the TFTs 31 is the same as the number of the pixel electrodes 30. The plurality of TFTs 31, 31, . . . correspond to the plurality of pixel electrodes 30, 30, . . . , respectively. The drain of each TFT 31 is connected to the corresponding pixel electrode 30.

The gates of a plurality of TFTs 31, 31, . . . located on each row are connected to a common gate line 32. The sources of a plurality of TFTs 31, 31, . . . located on each column are connected to a common source line 33. The two gate drivers 34r and 34f are provided in the TFT substrate 20. One end of each of the plurality of gate lines 32, 32, . . . is connected to the gate driver 34r located on the right side. The other end of each of the plurality of gate lines 32, 32, . . . is connected to the gate driver 34f located on the left side. The source driver 40 is provided in the printed circuit board 26. One end of each of the plurality of source lines 33, 33, . . . is connected to the source driver 40.

Each of the TFT 31, 31, . . . is of the N-channel type. A voltage can be applied to the pixel electrode 30 through the drain and source of the TFT 31 when the voltage value of the gate (hereinafter referred to as a gate voltage value) of the TFT 31 is higher than or equal to a predetermined voltage value. At this time, the TFT 31 is on. With the TFT 31, when the gate voltage value is lower than a predetermined voltage value, a voltage cannot be applied to the pixel electrode 30 through the drain and the source. At this time, the TFT 31 is off.

The gate drivers 34r and 34f supply, to the plurality of gate lines 32, 32, . . . , respective corresponding gate signals. The voltage value (gate voltage value) of the gate signal changes with time. The gate signal has a voltage value (high) for turning on a TFT and a voltage value (low) for turning off a TFT. This allows a plurality of TFTs 31, 31, . . . disposed on each row to be turned on or off. Typically, each gate line (pixel row) on which TFTs are to be turned on is sequentially selected using the gate signals (linear sequential driving).

The source driver 40 supplies, to the plurality of source lines 33, 33, . . . , respective corresponding source signals. The voltage value (source voltage value) of the source signal changes with time. This allows a pixel electrode 30 connected to a TFT 31 that is on to be supplied with a corresponding display signal voltage (corresponding to a source voltage value). Applied to the liquid crystal layer 23 of each pixel is a voltage corresponding to a potential difference between the pixel electrode 30 and the common electrode 21a. in the case where the potential of the pixel electrode 30 is represented using the potential of the common electrode 21a as a reference, the display signal voltage supplied to the pixel electrode 30 is applied to the liquid crystal layer 23 of each pixel.

A control circuit 50 is provided on the control circuit board 27. The control circuit 50 receives a video signal. The video signal is a set of image data of still images (frames) and changes with time. The control circuit 50 outputs a control signal based on the input video signal to each of the gate drivers 34r and 34f and the source driver 40. The gate drivers 34r and 34f each supply gate signals to the plurality of gate lines 32, 32, . . . according to a control signal input from the control circuit 50. The source driver 40 supplies source signals to the plurality of source lines 33, 33, . . . according to a control signal input from the control circuit 50.

The gate drivers 34r and 34f are each supplied with power from an upper side thereof. Therefore, the gate drivers 34r and 34f each receive a current from an upper side thereof. For the gate driver 34r, a monitor circuit 35ru is provided at a current input portion thereof where a current is input, and a monitor circuit 35rb is provided on a lower side thereof. Similarly, for the gate driver 34f, a monitor circuit 35fu is provided at a current input portion thereof where a current is input, and a monitor circuit 35fb is provided on a lower side thereof.

The monitor circuits 35ru and 35rb and the monitor circuits 35fu and 35fb are formed in the surrounding regions, near the gate drivers 34r and 34f, respectively, in a process of forming the gate drivers, and therefore, are shown in the gate drivers in FIG. 2.

In addition to the control circuit 50, constant-current circuits 51ru, 51rb, 51fu, and 51fb, and switches 52ru, 52rb, 52fu, and 52fb, are provided on the control circuit board 27. One end of the switch 52ru is connected to an output end of the constant-current circuit 51ru, and the other end of the switch 52ru is connected to the monitor circuit 35ru.

The constant-current circuit 51rb, the switch 52rb, and the monitor circuit 35rb are connected with each other similarly to the constant-current circuit 51ru, the switch 52ru, and the monitor circuit 35ru. The constant-current circuit 51fu, the switch 52fu, and the monitor circuit 35fu are also connected with each other similarly to the constant-current circuit 51ru, the switch 52ru, and the monitor circuit 35ru. The constant-current circuit 51fb, the switch 52fb, and the monitor circuit 35fb are also connected with each other similarly to the constant-current circuit 51ru, the switch 52ru, and the monitor circuit 35ru.

One end of each of the switches 52ru, 52rb, 52fu, and 52fb is connected to the control circuit 50.

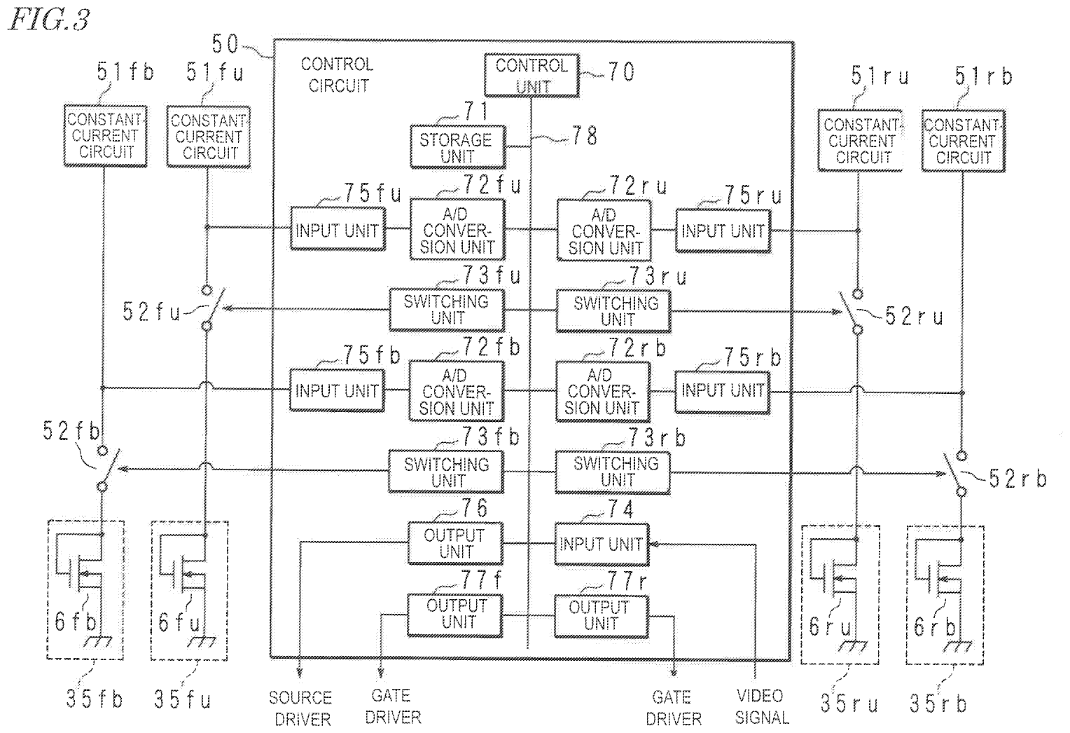

FIG. 3 is a diagram for describing the control circuit 50 and the monitor circuits 35ru, 35rb, 35fu, and 35fb. As shown in FIG. 3, the monitor circuits 35ru, 35rb, 35fu, and 35fb have N-channel type TFTs 6ru, 6rb, 6fu, and 6fb, respectively. A TFT included in a monitor circuit is also referred to as a “monitor TFT.” Each monitor circuit has a single monitor TFT. In each of the TFTs 6ru, 6rb, 6fu, and 6fb, the drain is connected to the gate, and the source is grounded. The TFTs 6ru, 6rb, 6fu, and 6fb are a so-called diode-connected TFT. The drain of the TFT 6ru, 6rb, 6fu, 6fb is connected to the other end of the switch 52ru, 52rb, 52fu, 52fb, respectively.

In each of the TFTs 6ru, 6rb, 6fu, and 6fb, a current flows through the drain and the source. In each of the TFTs 6ru, 6rb, 6fu, and 6fb, the resistance value between the drain and the source decreases with an increase in the gate voltage value relative to the potential of the source. In the TFTs 6ru, 6rb, 6fu, and 6fb, the source, the drain, and the gate correspond to a first end, a second end, and a control end, respectively.

Operations of the constant-current circuit 51ru, the switch 52ru, and the TFT 6ru will now be described. Operations of the constant-current circuit 51rb, the switch 52rb, and the TFT 6rb, operations of the constant-current circuit 51fu, the switch 52fu, and the TFT 6fu, and operations of the constant-current circuit 51fb, the switch 52fb, and the TFT 6fb, are similar to operations of the constant-current circuit 51ru, the switch 52ru, and the TFT 6ru. Therefore, these operations will not be described in detail.

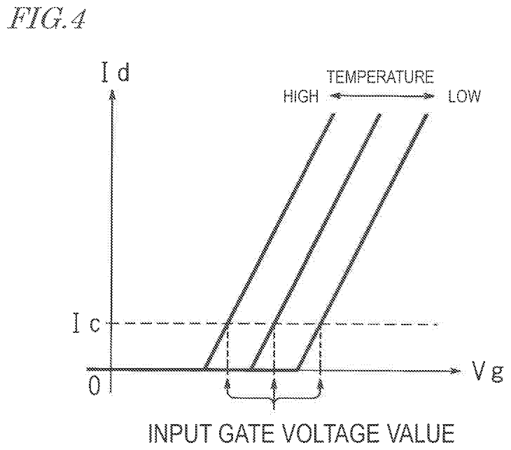

The switch 52ru is turned on or off by the control circuit 50. When the switch 52ru is on, the constant-current circuit 51ru supplies a current having a predetermined current value to the drain of the TFT 6ru through the switch 52ru. As a result, the gate voltage of the TFT 6ru settles to a certain value, so that the same current stably flows through the TFT 6ru and an interconnect (resistance). At this time, the gate voltage value of the TFT 6ru changes depending on the temperature of the TFT 6ru (see FIG. 4). The gate voltage value of the TFT 6ru is input through the switch 52ru to an input unit 75ru of the control circuit 50.

FIG. 4 is a diagram for describing the gate voltage value input to the control circuit 50. Assuming that the switch 52ru is on, the gate voltage value input to the control circuit 50 will be described.

FIG. 4 shows a relationship between a gate voltage value Vg and a drain current value Id in the case where the voltage value between the drain and source of the TFT 6ru is fixed to a predetermined voltage value. The gate voltage value Vg is a voltage value relative to a ground potential, and the drain current value Id is the current value of a current flowing through the drain and the source.

As shown in FIG. 4, when the gate voltage value vg exceeds a voltage threshold, the drain current value Id exceeds zero. Thereafter, as the gate voltage value Vg increases, the drain current value Id also increases. The voltage threshold increases with a decrease in the temperature of the TFT 6ru. The control circuit 50 receives a gate voltage value when the drain current value Id is equal to a predetermined current value Ic. The gate voltage value input to the control circuit 50 increases with a decrease in the temperature of the TFT 6ru.

When the switch 52ru is off, the constant-current circuit 51ru does not supply a current. Therefore, power is not consumed in the TFT 6ru.

The constant-current circuits 51rb, 51fu, and 51fb also supply a current having a predetermined current value to the drains of the TFT 6rb, 6fu, and 6fb, respectively. The gate voltage value Vg vs. drain current value Id characteristics of the TFTs 6rb, 6fu, and 6fb are similar to the gate voltage value Vg vs. drain current value Id characteristics of the TFT 6ru (see FIG. 4).

Note that because of manufacturing variations, it is difficult to manufacture the TFTs 6ru, 6rb, 6fu, and 6fb having the same gate voltage value that is to be input to the control circuit 50. Therefore, there is a possibility that even when the TFTs 6ru, 6rb, 6fu, and 6fb all have the same predetermined temperature, the gate voltage values to be input to the control circuit 50 are not the same. In the description that follows, it is assumed that even when the TFTs 6ru, 6rb, 6fu, and 6fb all have the same predetermined temperature, the gate voltage values to be input to the control circuit 50 may not be the same. Here, the predetermined temperature may, for example, be a maximum temperature at which the TFT can operate normally.

As shown in FIG. 3, the control circuit 50 includes a control unit 70, a storage unit 71, analog/digital (A/D) conversion units 72ru, 72rb, 72fu, and 72fb, switching units 73ru, 73rb, 73fu, and 73fb, input units 74, 75ru, 75rb, 75fu, and 75fb, and output units 76, 77r, and 77f. The control unit 70, the storage unit 71, the A/D conversion units 72ru, 72rb, 72fu, and 72fb, the switching units 73ru, 73rb, 73fu, and 73fb, the input unit 74, and the output units 76, 77f, and 77r are each connected to a bus line 78.

The A/D conversion units 72ru, 72rb, 72fu, and 72fb are further connected to the input units 75ru, 75rb, 75fu, and 75fb, respectively. The input unit 75ru, 75rb, 75fu, 75fb is further connected to one end of the switch 52ru, 52rb, 52fu, 52fb, respectively.

The switching unit 73ru turns on or off the switch 52ru according to an instruction from the control unit 70. When the switch 52ru is on, the gate voltage value of the TFT 6ru relative to the ground potential is input to the input unit 75ru. The gate voltage value input to the input unit 75ru is an analog value. The input unit 75ru, when receiving the analog gate voltage value, outputs the input analog gate voltage value to the A/D conversion unit 72ru.

The A/D conversion unit 72ru converts the analog gate voltage value input from the input unit 75ru into a digital gate voltage value. The digital gate voltage value obtained by the conversion performed by the A/D conversion unit 72ru is acquired by the control unit 70. The gate voltage value acquired by the control unit 70 is, at the time of the acquisition, substantially equal to the gate voltage value input to the input unit 75ru.

Note that the input of the gate voltage value to the input unit 75ru corresponds to the detection of the gate voltage value by the input unit 75ru.

The A/D conversion unit 72rb, the switching unit 73rb, and the input unit 75rb operate similarly to the A/D conversion unit 72ru, the switching unit 73ru, and the input unit 75ru. The A/D conversion unit 72fu, the switching unit 73fu, and the input unit 75fu also operate similarly to the A/D conversion unit 72ru, the switching unit 73ru, and the input unit 75ru. The A/D conversion unit 72fb, the switching unit 73fb, and the input unit 75fb also operate similarly to the A/D conversion unit 72ru, the switching unit 73ru, and the input unit 75ru.

Note that the switching units 73rb, 73fu, and 73fb turn on or off the switches 52rb, 52fu, and 52fb, respectively. The input units 75rb, 75fu, and 75fb receive the gate voltage values of the TFTs 6rb, 6fu, and 6fb, respectively.

The input unit 74 receives a video signal.

The output unit 76 outputs a control signal to the source driver 40 according to an instruction from the control unit 70. The source driver 40 supplies source signals to the respective corresponding source lines 33, 33, . . . according to a control signal input from the output unit 76.

The output units 77r and 77f output a control signal to the gate drivers 34r and 34f, respectively, according to an instruction from the control unit 70. The gate drivers 34r and 34f supply gate signals to the respective corresponding gate lines 32, 32, . . . according to the control signals input from the output units 77r and 77f.

The storage unit 71 is, for example, a non-volatile memory. The storage unit 71 stores a computer program. The control unit 70 has a central processing unit (CPU) that is not shown. The CPU of the control unit 70 executes the computer program stored in the storage unit 71 to execute a display process and a protection process. The display process is a process for displaying an image on the front surface of the display panel 10. The protection process is a process of investigating whether or not there is a local temperature increase in the gate driver or the source driver, and when a local temperature increase in the gate driver or the source driver is detected, protecting the display panel 10 from an abnormal temperature increase. The CPU of the control unit 70 executes the computer program stored in the storage unit 71 to enable the control unit 70 to operate as a temperature difference detection circuit as described below. In the first embodiment, the temperature difference detection circuit detects a difference between the temperatures of a first TFT and a second TFT that are formed near a driver, on the basis of the gate voltages of the first and second TFTs that occur when a predetermined current is supplied to the drain of each of the first and second TFTs.

The control unit 70 periodically executes the display process. In the display process, the control unit 70 generates three control signals based on a video signal input to the input unit 74. Next, the control unit 70 outputs the three control signals thus generated to the output units 76, 77r, and 77f, respectively. As described above, the source driver 40 supplies source signals to the respective corresponding source lines 33, 33, . . . according to the input control signal, and the gate drivers 34r and 34f each supply gate signals to the respective corresponding gate lines 32, 32, . . . according to the input control signal. As a result, as long as the backlight device 11 is emitting light to the display panel 10, an image based on a video signal input to the input unit 74 is displayed on the front surface of the display panel 10.

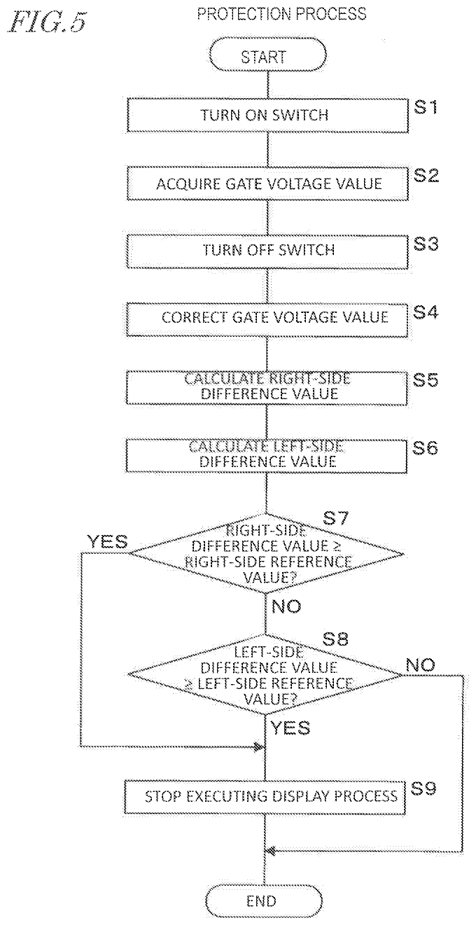

FIG. 5 is a flowchart showing steps of the protection process. The control unit 70 periodically executes the protection process. In the protection process, initially, the control unit 70 instructs the switching units 73ru, 73rb, 73fu, and 73fb to turn on the switches 52ru, 52rb, 52fu, and 52fb (step S1). After a predetermined time has elapsed since the execution of step S1, the control unit 70 acquires the gate voltage values of the TFTs 6ru, 6rb, 6fu, and 6fb from the A/D conversion units 72ru, 72rb, 72fu, and 72fb (step S2). Here, the predetermined time is longer than or equal to the time it takes the gate voltage values of the TFTs 6ru, 6rb, 6fu, and 6fb to become stable after the execution of step S1.

After the execution of step S2, the control unit 70 instructs the switching units 73ru, 73rb, 73fu, and 73fb to turn off the switches 52ru, 52rb, 52fu, and 52fb (step S3). Next, the control unit 70 corrects the gate voltage values of the TFTs 6ru and 6fu acquired in step S2 (step S4).

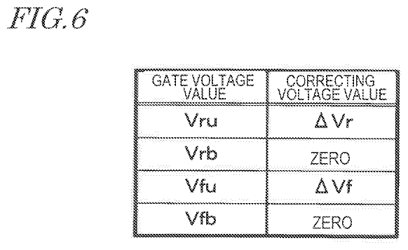

FIG. 6 is a diagram showing a table indicating a relationship between gate voltage values and correcting voltage values (also referred to as “characteristic difference values”). The storage unit 71 stores correcting voltage values in association with gate voltage values Vru, Vrb, Vfu, and Vfb that are input to the input units 75ru, 75rb, 75fu, and 75fb when the switches 52ru, 52rb, 52fu, and 52fb are on, respectively. The gate voltage values Vru, Vrb, Vfu, and Vfb are voltage values relative to the ground potential.

The gate voltage value Vru is associated with a correcting voltage value ΔVr, and the gate voltage value Vrb is associated with zero V. The correcting voltage value ΔVr is calculated by subtracting the gate voltage value Vrb that occurs when the temperature of the TFT 6rb is a predetermined temperature from the gate voltage value Vru that occurs when the temperature of the TFT 6ru is the predetermined temperature. The correcting voltage value ΔVr may have a negative value.

Similarly, the gate voltage value Vfu is associated with a correcting voltage value ΔVf, and the gate voltage value Vfb is associated with zero V. The correcting voltage value ΔVf is calculated by subtracting the gate voltage value Vfb chat occurs when the temperature of the TFT 6fb is a predetermined temperature from the gate voltage value Vfu that occurs when the temperature of the TFT 6fu is the predetermined temperature. The correcting voltage value ΔVf may have a negative value.

In step S4 of FIG. 5, the control unit 70 subtracts the correcting voltage value ΔVr from the gate voltage value Vru acquired from the A/D conversion unit 72ru, and subtracts the correcting voltage value ΔVr from the gate voltage value Vfu acquired from the A/D conversion unit 72fu. As a result, the gate voltage values Vru and Vfu are corrected.

Next, the control unit 70 calculates a right-side difference value that is a difference value between the gate voltage values Vru and Vrb including the gate voltage value Vru corrected in step S4 (step S5). The right-side difference value is an absolute value. The right-side difference value indicates a temperature difference between two portions of the display panel 10 where the TFTs 6ru and 6rb are located. The right-side difference value increases with an increase in the temperature difference. Therefore, by executing step S5, the control unit 70 can appropriately detect a temperature difference between a plurality of portions where the TFTs 6ru and 6rb are located. In addition, because the gate voltage value Vru is corrected, even when there is a difference between the characteristics of the TFT 6ru and the characteristics of the TFT 6rb due to manufacturing variations, the control unit 70 can appropriately detect a temperature difference between the TFT 6ru and the TFT 6rb, on the basis of the right-side difference value.

Next, the control unit 70 calculates a left-side difference value that is a difference value between the gate voltage values Vfu and Vfb including the gate voltage value Vfu corrected in step S4 (step S6). The left-side difference value is an absolute value. The left-side difference value indicates a temperature difference between two portions of the display panel 10 where the TFTs 6fu and 6fb are located. The left-side difference value increases with an increase in the temperature difference. Therefore, by executing step S6, the control unit 70 can appropriately detect a temperature difference between a plurality of portions where the TFTs 6fu and 6fb are located. In addition, because the gate voltage value Vfu is corrected, even when there is a difference between the characteristics of the TFT 6fu and the characteristics of the TFT 6fb due to manufacturing variations, the control unit 70 can appropriately detect a temperature difference between the TFTs 6fu and the TFT 6fb on the basis of the left-side difference value.

Note that when the gate voltage values Vru and Vrb that occur when the temperatures of the TFTs 6ru and 6rb are a predetermined temperature are substantially equal to each other, it is not necessary to correct the gate voltage value Vru. At this time, it is not necessary to correct the gate voltage value Vru or Vrb. Similarly, when the gate voltage values Vfu and Vfb that occur when the temperature of the TFTs 6fu and 6fb are a predetermined temperature are substantially equal to each other, it is not necessary to correct the gate voltage value Vfu. At this time, it is not necessary to correct the gate voltage value Vfu or Vfb. When none of the gate voltage values Vru and Vfu is required to be corrected, the control unit 70 executes step S5 after executing step S3. In steps S5 and S6, the four gate voltage values acquired in step S2 are used.

After executing step S6, the control unit 70 determines whether or not the right-side difference value calculated in step S5 is greater than or equal to a right-side reference value (step S7). The right-side reference value is a constant value and is previously set. By the execution of step S7, it is determined whether or not a temperature difference between a plurality of portions where the TFTs 6ru and 6rb are located is greater than or equal to a predetermined first threshold.

If it is determined in step S7 that the right-side difference value is smaller than the right-side reference value (S7: NO), the control unit 70 determines whether or not the left-side difference value calculated in step S6 is greater than or equal to a left-side reference value (step S8). The left-side reference value is also a constant value and is previously set. By the execution of step S8, it is determined whether or not a temperature difference between a plurality of portions where the TFTs 6fu and 6fb are located is greater than or equal to a predetermined second threshold.

The condition that the right-side difference value is greater than or equal to the right-side reference value corresponds to the condition that a temperature difference between a plurality of portions where the TFTs 6ru and 6rb are located is greater than or equal to the first threshold. Therefore, the determination that the right-side difference value is greater than or equal to the right-side reference value corresponds to the detection that a temperature difference between a plurality of portions where the TFTs 6ru and 6rb are located is greater than or equal to the first threshold. In addition, the condition that the left-side difference value is greater than or equal to the left-side reference value corresponds to the condition that a temperature difference between a plurality of portions where the TFTs 6fu and 6fb are located is greater than or equal to the second threshold. Therefore, the determination that the left-side difference value is greater than or equal to the left-side reference value corresponds to the detection that a temperature difference between a plurality of portions where the TFTs 6fu and 6fb are located is greater than or equal to the second threshold.

If the control unit 70 determines that the right-side difference value is greater than or equal to the right-side reference value (S7: YES) or that the left-side difference value is greater than or equal to the left-side reference value (S8: YES), the control unit 70 stops the execution of the display process, assuming that a temperature difference between a plurality of portions in one of the gate drivers 34r and 34f is greater than or equal to a predetermined value (step S9). Specifically, for example, the control unit 70 stops the output units 76, 77r, and 77f from outputting a control signal. As a result, the temperature of the gate driver 34r or 34f decreases, and therefore, the display panel 10 is protected from an abnormal temperature increase.

Note that the order in which steps S5-S8 are executed is not limited to the above example. Steps S5-S8 may be executed in any order as long as step SI is executed after step S5, and step S8 is executed after step S6. For example, step S5, step S7, step S6, and step S8 may be executed in this order. For example, after steps S5 and S1, steps S6 and S8 may be executed only if the result of step S1 is negative (NO).

After executing step S9, the control unit 70 ends the protection process. In this case, even in the next interval, the control unit 70 does not execute the protection process.

If the control unit 70 determines that the left-side difference value is smaller than the left-side reference value (S8: NO), the control unit 70 ends the protection process. In this case, in the next interval, the control unit 70 executes the protection process again.

Note that in step S9, the control unit 70 may not stop the display process, and if determining that the right-side difference value is greater than or equal to the right-side reference value, may stop the output unit 77r from outputting a control signal to the gate driver 34r, and if determining that the left-side difference value is greater than or equal to the left-side reference value, may stop the output unit 77f from outputting a control signal to the gate driver 34f. In this case, the control unit 70 periodically executes the protection process even after ending the protection process via executing step S9.

In the display panel 10 thus configured, the temperature difference is detected using a small number of TFTs, and therefore, it is easy to correct the gate voltage values Vru and Vrb input to the input units 75ru and 75rb, or the gate voltage values Vfu and Vfb input to the input units 75fu and 75fb. As a result, the manufacturing cost of the display panel 10 is low.

In the foregoing, an example has been described in which the two monitor circuits 35ru and 35rb and two monitor circuits 35fu and 35fb (the two monitor TFTs 6ru and 6rb and the two monitor TFTs 6fu and 6fb) are provided in the two gate drivers 34r and 34f, respectively, that are located in regions facing each other with the display region interposed therebetween. Alternatively, three or more monitor circuits may be provided in one gate driver. One of the three or more monitor circuits may be designated as a reference monitor circuit, and difference values between the gate voltage of a TFT in the reference monitor circuit and the gate voltages of TFTs in the other two or more monitor circuits may be calculated. The two or more difference values thus acquired may be compared with a reference value, and determination may be performed in a manner similar to that described above. In any embodiments of the present invention, three or more monitor circuits may be provided in one gate driver. The present invention is similarly applicable to the case where a source driver is integrated. In addition, in any embodiments of the present invention, the detection of a temperature increase using a plurality of monitor TFTs may be performed in at least one driver.

In this embodiment, a local temperature increase in a driver can be detected, separately from a global temperature increase in a display panel. This advantage is common to all embodiments below.

### Second Embodiment

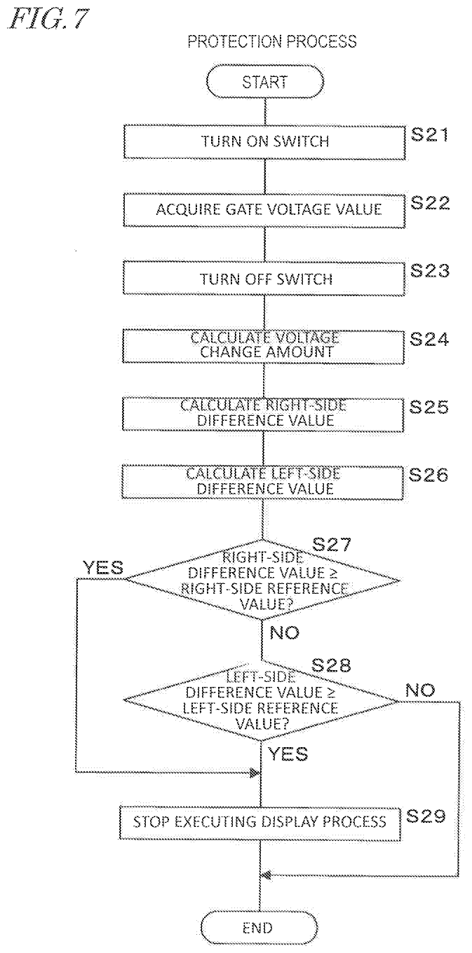

FIG. 7 is a flowchart showing steps of a protection process in a second embodiment. Differences between the second embodiment and the first embodiment will now be described. Parts other than those described below are the same as those of the first embodiment, and therefore, parts common to the second and first embodiments are indicated by the same reference characters that are used in the first embodiment and will not be described.

A display apparatus 1 in the second embodiment is different from that in the first embodiment in that the protection process executed by the control unit 70 of the control circuit 50 included in the display panel 10.

As in the first embodiment, the control unit 70 periodically executes a protection process in the second embodiment. Steps S21-S23 and S27-S29 of the protection process in the second embodiment are similar to steps S1-S3 and S7-S9, respectively, of the protection process in the first embodiment. Therefore, steps S21-S23 and S27-S29 will not be described in detail.

In the storage unit 71, set voltage values (also referred to as “characteristic values”) Vr1, Vr2, Vf1, and Vf2 are previously set in association with a plurality of TFTs 6ru, 6rb, 6fu, and 6fb, respectively. The set voltage value Vr1 is a gate voltage value Vru that occurs when the temperature of the TFT 6ru is a predetermined temperature. Similarly, the set voltage value Vr2 is a gate voltage value Vrb that occurs when the temperature of the TFT 6rb is the predetermined temperature. The set voltage value Vf1 is a gate voltage value Vfu that occurs when the temperature of the TFT 6fu is the predetermined temperature. The set voltage value Vf2 is a gate voltage value Vfb that occurs when the temperature of the TFT 6fb is the predetermined temperature.

After executing step S23, the control unit 70 calculates voltage change amounts of the gate voltage values Vru, Vrb, Vfu, and Vfb acquired in step S22 from the set voltage values Vr1, Vr2, Vf1, and Vf2, respectively, that are previously set in association the TFTs 6ru, 6rb, 6fu, and 6fb, respectively (step S24).

The voltage change amount of the gate voltage value Vru is calculated by subtracting the set voltage value Vr1 from the gate voltage value Vru, and indicates a temperature difference calculated by subtracting the predetermined temperature from the temperature of a portion where the TFT 6ru is located.

Similarly, the voltage change amount of the gate voltage value Vrb is calculated by subtracting the set voltage value Vr2 from the gate voltage value Vrb, and indicates a temperature difference calculated by subtracting the predetermined temperature from the temperature of a portion where the TFT 6rb is located. The voltage change amount of the gate voltage value Vfu is calculated by subtracting the set voltage value Vf1 from the gate voltage value Vfu, and indicates a temperature difference calculated by subtracting the predetermined temperature from the temperature of a portion where the TFT 6fu is located. The voltage change amount of the gate voltage value Vfb is calculated by subtracting the set voltage value Vf2 from the gate voltage value Vfb, and indicates a temperature difference calculated by subtracting the predetermined temperature from the temperature of a portion where the TFT 6fb is located.

Next, the control unit 70 calculates a right-side difference value that is a difference value between the voltage change amount of the gate voltage value Vru and the voltage change amount of the gate voltage value Vrb (step S25). The right-side difference value is an absolute value. The right-side difference value indicates a temperature difference between a plurality of portions where the TFTs 6ru and 6rb are located in the display panel 10. The right-side difference value increases with an increase in the temperature difference. Therefore, by executing step S25, the control unit 70 can appropriately detect a temperature difference between a plurality of portions where the TFTs 6ru and 6rb are located. In addition, because the right-side difference value is a difference value between two voltage change amounts, and therefore, even when there is a difference between the characteristics of the TFT 6ru and the characteristics of the TFT 6rb due to manufacturing variations, the control unit 70 can appropriately detect a temperature difference between the TFT 6ru and the TFT 6rb on the basis of the right-side difference value.

Next, the control unit 70 calculates a left-side difference value that is a difference value between the voltage change amount of the gate voltage value Vfu and the voltage change amount of the gate voltage value Vfb (step S26). The left-side difference value is an absolute value. The left-side difference value indicates a temperature difference between a plurality of portions where the TFTs 6fu and 6fb are located in the display panel 10. The left-side difference value increases with an increase in the temperature difference. Therefore, by executing step S26, the control unit 70 can appropriately detect a temperature difference between a plurality of portions where the TFTs 6fu and 6fb are located. In addition, because the left-side difference value is a difference value between two voltage change amounts, even when there is a difference between the characteristics of the TFT 6fu and the characteristics of the TFT 6fb due to manufacturing variations, the control unit 70 can appropriately detect a temperature difference between the TFT 6fu and the TFT 6fb on the basis of the left-side difference value. After executing step S26, the control unit 70 executes step S27.

The display panel 10 in the second embodiment has an effect similar to that of the display panel 10 in the first embodiment. Note that in the case where a difference from the set voltage value is used as in the second embodiment, the temperature increase can be detected using only one monitor circuit (monitor TFT).

### Third Embodiment

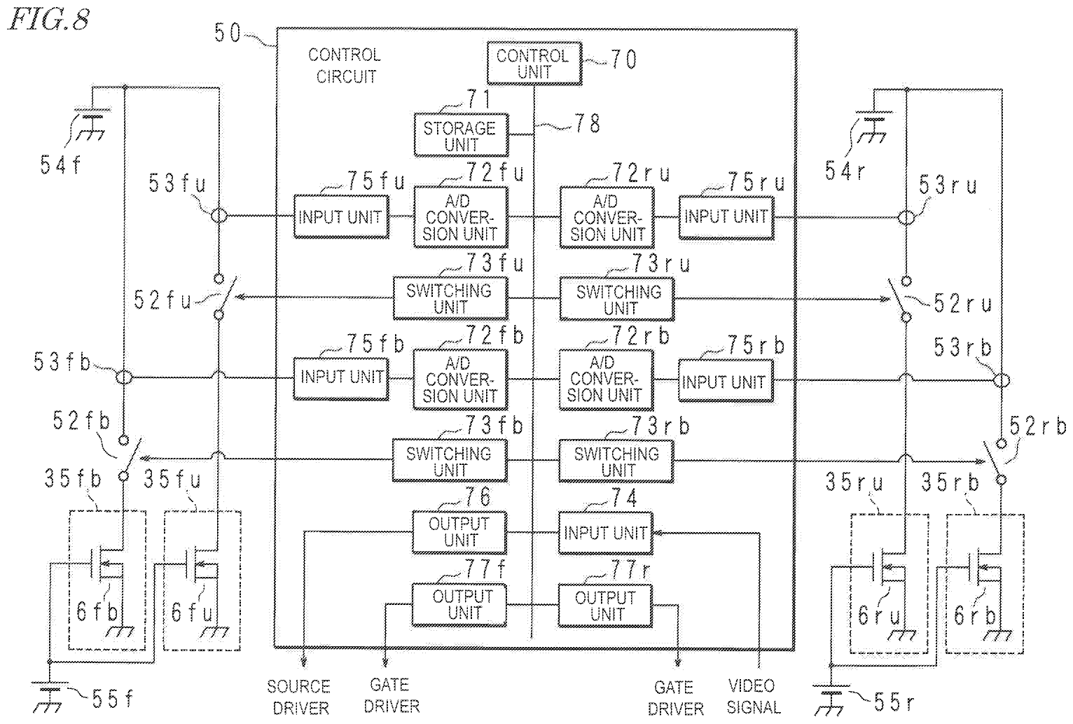

FIG. 8 is a diagram for describing a control circuit 50 and monitor circuits 35ru, 35rb, 35fu, and 35fb in a third embodiment.

Differences between the third embodiment and the first embodiment will now be described. Parts other than those described below are the same as those of the first embodiment, and therefore, parts common to the third and first embodiments are indicated by the same reference characters that are used in the first embodiment and will not be described.

In the third embodiment, a temperature difference detection circuit detects a difference between the temperatures of a first TFT and a second TFT that are formed near a driver, on the basis of drain currents of the first and second TFTs that occur when a predetermined direct-current voltage is supplied to the gates of the first and second TFTs.

A display panel 10 in the third embodiment has the same parts as those of the display panel 10 in the first embodiment, except for the constant-current circuits 51ru, 51rb, 51fu, and 51fb. The display panel 10 in the third embodiment further has current sensors 53ru, 53rb, and 53fu, 53fb, and direct-current power supplies 54r, 54f, 55r, and 55f.

The positive terminal of the direct-current power supply 54r is connected to one end of each of the switches 52ru and 52rb, and the negative terminal of the direct-current power supply 54r is grounded. The current sensor 53ru, which has a loop shape, surrounds a conducting wire connecting the direct-current power supply 54r and the switch 52ru with each other. The current sensor 53rb, which has a loop shape, surrounds a conducting wire connecting the direct-current power supply 54r and the switch 52rb with each other. The other end of the switch 52ru, 52rb is connected to the drain of the TFT 6ru, 6rb, respectively. The source of each of the TFTs 6ru and 6rb is grounded.

The positive terminal of the direct-current power supply 55r is connected to the gates of the TFTs 6ru and 6rb. The negative terminal of the direct-current power supply 55r is grounded. Therefore, the gate of each of the TFTs 6ru and 6rb is connected to the positive terminal of the direct-current power supply 55r. Therefore, a predetermined voltage (direct-current voltage) having the same the voltage value is applied to the gate of each of the TFTs 6ru and 6rb.

Similarly, the positive terminal of the direct-current power supply 54f is connected to one end of each of the switches 52fu and 52fb, and the negative terminal of the direct-current power supply 54f is grounded. The current sensor 53fu, which has a loop shape, surrounds a conducting wire connecting the direct-current power supply 54f and the switch 52fu with each other. The current sensor 53fb, which has a loop shape, surrounds a conducting wire connecting the direct-current power supply 54f and the switch 52fb with each other. The other end of the switch 52fu, 52fb is connected to the drain of the TFT 6fu, 6fb, respectively. The source of each of the TFTs 6fu and 6fb is grounded.

The positive terminal of the direct-current power supply 55f is connected to the gates of the TFTs 6fu and 6fb. The negative terminal of the direct-current power supply 55f is grounded. Therefore, the gate of each of the TFTs 6fu and 6fb is connected to the positive terminal of the direct-current power supply 55f. Therefore, a predetermined voltage (direct-current voltage) having the same the voltage value is applied to the gate of each of the TFTs 6fu and 6fb.

When the switch 52ru is on, a current flows from the direct-current power supply 54r to the switch 52ru and the TFT 6ru in this order. At this time, in the TFT 6ru, a current flows through the drain and the source. When the switch 52ru is on and the direct-current power supply 55r is applying a predetermined voltage to the gate of the TFT 6ru, the current sensor 53ru detects a drain current value of a current that flows through the drain and source of the TFT 6ru. The current sensor 53ru outputs analog current information indicating the detected drain current value to the control circuit 50. The current information is, for example, a current value or voltage value that changes depending on the detected drain current value.

When the switch 52ru is off, a current does not flow through the TFT 6ru, and therefore, power is not consumed in the TFT 6ru.

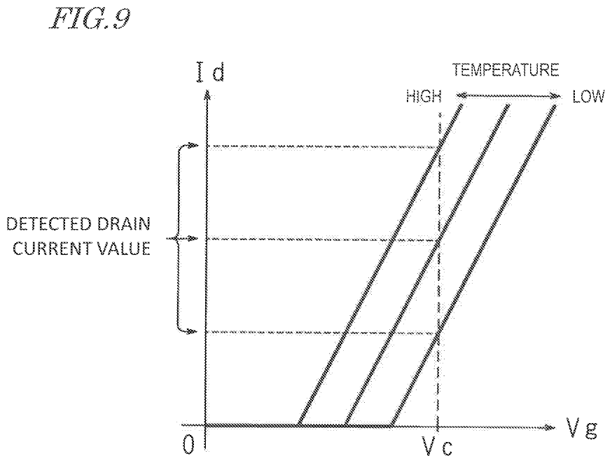

FIG. 9 is a diagram for describing the drain current value detected by the current sensor 53ru. The drain current value detected by the current sensor 53ru will be described, assuming that the switch 52ru is on.

As with FIG. 4, FIG. 9 shows a relationship between a gate voltage value Vg and a drain current value Id that occur when the voltage value between the drain and source of the TFT 6ru is fixed to a predetermined voltage value. The relationship between the gate voltage value Vg and the drain current value id shown in FIG. 9 is the same as that shown in FIG. 4.

The current sensor 53ru detects the drain current value Id that occurs when the gate voltage value Vg is equal to an output voltage value Vc of the direct-current power supply 55r. Therefore, the drain current value Id detected by the current sensor 53ru decreases with a decrease in the temperature of the TFT 6ru.

The TFT 6rb, the switch 52rb, and the current sensor 53rb operate similarly to the TFT 6ru, the switch 52ru, and the current sensor 53ru.

The TFT 6fu, the switch 52fu, the current sensor 53fu, and the direct-current power supplies 54f and 55f operate similarly to the TFT 6ru, the switch 52ru, the current sensor 53ru, and the direct-current power supplies 54r and 55r. The TFT 6fb, the switch 52fb, the current sensor 53fb, and the direct-current power supplies 54f and 55f also operate similarly to the TFT 6ru, the switch 52ru, the current sensor 53ru, and the direct-current power supplies 54r and 55r.

The gate voltage value Vg vs. drain current value Id characteristics of the TFTs 6rb, 6fu, and 6fb are similar to those of the TFT 6ru (see FIG. 9).

Note that because of manufacturing variations, it is difficult to manufacture the TFTs 6ru, 6rb, 6fu, and 6fb that have the same drain current value that is to be detected by the current sensor 53ru.

Therefore, there is a possibility that even when the TFTs 6ru, 6rb, 6fu, and 6fb all have a predetermined temperature, the drain current values to be detected by the current sensors 53ru, 53rb, 53fu, and 53fb are not the same. In the description that follows, it is assumed that ever, when the TFTs 6ru, 6rb, 6fu, and 6fb all have a predetermined temperature, the drain current values to be detected by the current sensors 53ru, 53rb, 53fu, and 53fb are different from each other.

The control circuit 50 in the third embodiment has all the parts included in the control circuit 50 in the first embodiment. The control circuit 50 in the third embodiment is different from the control circuit 50 in the first embodiment in that the input unit 75ru, 75rb, 75fu, 75fb is connected to the current sensor 53ru, 53rb, 53fu, 53fb, respectively, instead of one end of the switch 52ru, 52rb, 52fu, 52fb.

When the switch 52ru is on, the current sensor 53ru detects the drain current value of the TFT 6ru, and outputs analog current information indicating the detected drain current value to the input unit 75ru. The input unit 75ru, when receiving the analog current information, outputs the input analog current information to the A/D conversion unit 72ru.

The A/D conversion unit 72ru converts the analog current information input from the input unit 75ru into digital current information. The digital current information obtained by the conversion performed by the A/D conversion unit 72ru is acquired by the control unit 70. The drain current value indicated by the current information acquired by the control unit 70 is, at the time of the acquisition, substantially equal to the drain current value detected by the current sensor 53ru.

The A/D conversion unit 72rb, the switching unit 73rb, and the input unit 75rb operate similarly to the A/D conversion unit 72ru, the switching unit 73ru, and the input unit 75ru. The A/D conversion unit 72fu, the switching unit 73fu, and the input unit 75fu also operate similarly to the A/D conversion unit 72ru, the switching unit 73ru, and the input unit 75ru. The A/D conversion unit 72fb, the switching unit 73fb, and the input unit 75fb also operate similarly to the A/D conversion unit 72ru, the switching unit 73ru, and the input unit 75ru.

Note that the switching units 73rb, 73fu, and 73fb turn on or off the switches 52rb, 52fu, and 52fb, respectively. The input units 75rb, 75fu, and 75fb receive current information indicating the drain current values detected by the current sensors 53rb, 53fu, and 53fb, respectively.

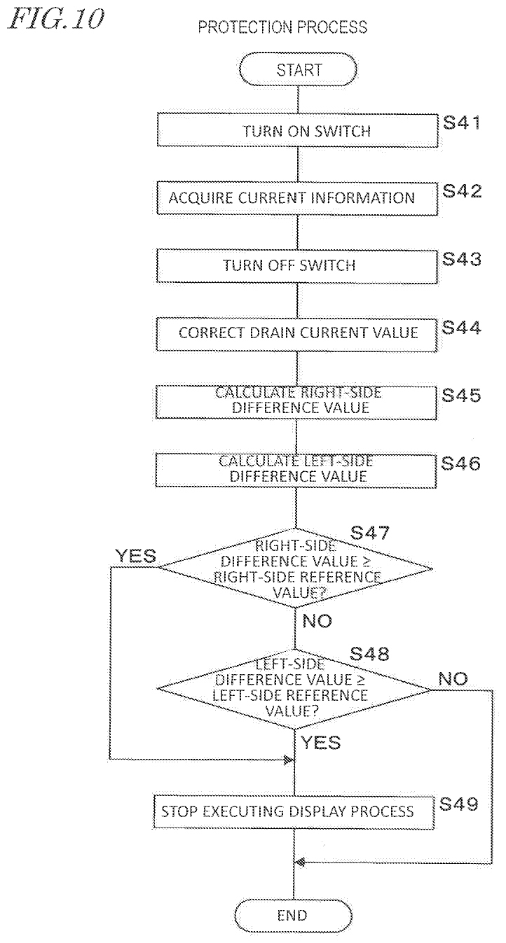

FIG. 10 is a flowchart showing steps or a protection process. As in the first embodiment, the control unit 70 periodically executes the protection process. Steps S41, S43, and S47-S49 of the protection process in the third embodiment are similar to steps S1, S3, and S7-S9 of the protection process in the first embodiment. Therefore, steps S41, S43, and S47-S49 will not be described in detail.

After executing step S41, the control unit 70 acquires four pieces of current information indicating the drain current values of the TFTs 6ru, 6rb, 6fu, and 6fb from the A/D conversion units 72ru, 72rb, 72fu, and 72fb, respectively (step S42). After executing step S42, the control unit 70 executes step S43. After executing step S43, the control unit 70 corrects the drain current values indicated by two pieces of current information about the TFTs 6ru and 6fu that have been acquired in step S42 (step S44).

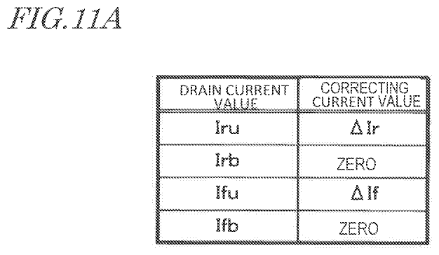

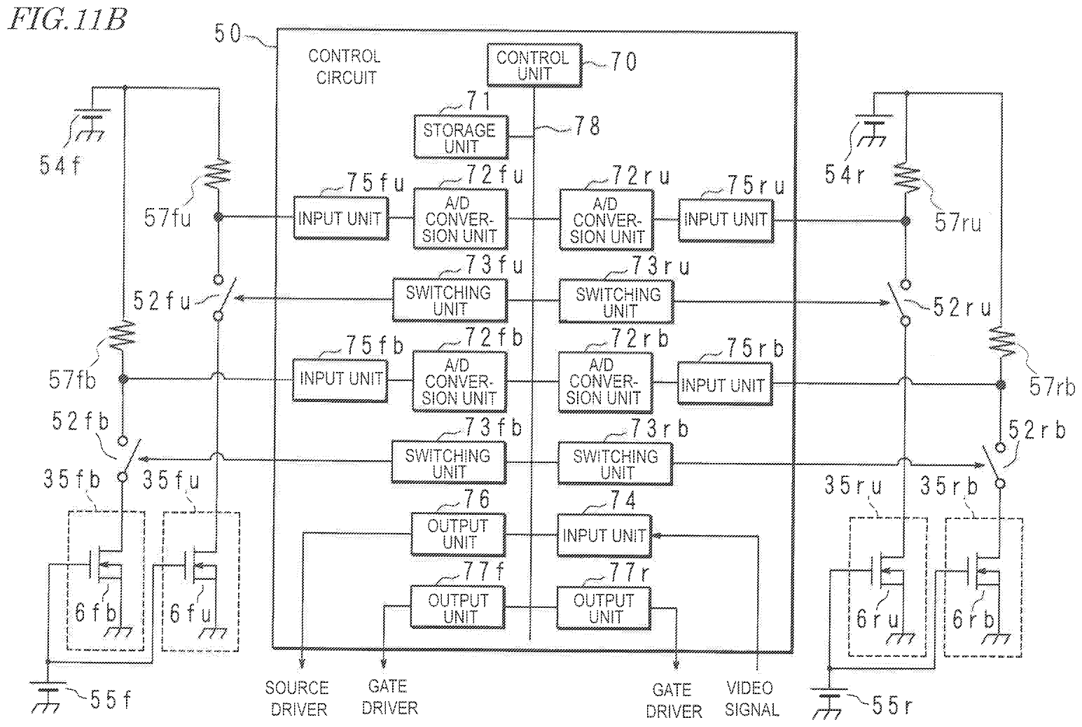

FIG. 11A is a diagram showing a table indicating a relationship between drain current values and correcting current values (also referred to as “characteristic difference values”). The storage unit 71 stores correcting current values in association with drain current values Δru, Irb, Ifu, and Ifb detected by the current sensors 53ru, 53rb, 53fu, and 53fb when the switches 52ru, 52rb, 52fu, and 52fb are on, respectively.

The drain current value Iru is associated with a correcting current value ΔIr, and the drain current value Irb is associated with zero A. The correcting current value ΔIr is calculated by subtracting the drain current value Irb that occurs when the temperature of the TFT 6rb is a predetermined temperature, from the drain current value Iru that occurs when the temperature of the TFT 6ru is the predetermined temperature. There is a possibility that the correcting current value ΔIr is a negative value.

Similarly, the drain current value Ifu is associated with a correcting current value ΔIf, and the drain current value Δfb is associated with zero A. The correcting current value ΔIf is calculated oy subtracting the drain. current value Ifb that occurs when the temperature of the TFT 6fb is a predetermined temperature, from the drain current value Ifu that occurs when the temperature of the TFT 6fu is the predetermined temperature. There is a possibility that the correcting current value ΔIf is a negative value.

In step S44 of FIG. 10, the control unit 70 subtracts the correcting current value ΔIr from the drain current value Iru indicated by the current information acquired from the A/D conversion unit 72ru, and subtracts the correcting current value if from the drain current value Ifu indicated by the current information acquired from the A/D conversion unit 72fu. As a result, the drain current values Iru and Ifu are corrected.

Next, the control unit 70 calculates a right-side difference value that is a difference value between the drain current values Iru and Irb including the drain current value Iru corrected in step S44 (step S45). The right-side difference value is an absolute value. The right-side difference value indicates a temperature difference between two portions where the TFTs 6ru and 6rb are located in the display panel 10. The right-side difference value increases with an increase in the temperature difference. Therefore, by executing step S45, the control unit 70 can appropriately detect a temperature difference between two portions where the TFTs 6ru and 6rb are located. In addition, because the drain current value Iru is corrected, even when there is a difference between the characteristics of the TFT 6ru and the characteristics of the TFT 6rb due to manufacturing variations, the control unit 70 can appropriately detects a temperature difference between the TFT 6ru and the TFT 6rb on the basis of the right-side difference value.

Next, the control unit 70 calculates a left-side difference value that is a difference value between the drain current values Ifu and Ifb including the drain current value Ifu corrected in step S44 (step S46). The left-side difference value an absolute value. The left-side difference value indicates a temperature difference between two portions where the TFTs 6fu and 6fb are located in the display panel 10. The left-side difference value increases with an increase in the temperature difference. Therefore, by executing step S46, the control unit 70 can appropriately detect a temperature difference between two portions where the TFTs 6fu and 6fb are located. In addition, because the drain current value Ifu is corrected, even when there is a difference between the characteristics of the TFT 6fu and the characteristics of the TFT 6fb due to manufacturing variations, the control unit 70 can appropriately detects a temperature difference between the TFT 6fu and the TFT 6fb on the basis of the left-side difference value. After executing step S46, the control unit 70 executes step S47.

Note that if the drain current values Iru and Irb are substantially equal to each other when the temperatures of the TFTs 6ru and 6rb are the predetermined temperature, it is not necessary to correct the drain current value Iru. At this time, it is not necessary to correct the drain current value Iru or Irb. Similarly, if the drain current values Ifu and Ifb are substantially equal to each other when the temperatures of the TFTs 6fu and 6fb are the predetermined temperature, it is not necessary to correct the drain current value Ifu. At this time, it is not necessary to correct the drain current value Ifu or Ifb. When none of the drain. current values Iru and Ifu is required to be corrected, the control unit 70 executes step S45 after executing step S43. In steps S45 and S46, the drain current values Iru, Irb, Ifu, and Ifb indicated by the four pieces of current information acquired in step S42 are used.

In the display panel 10 thus configured, the temperature difference is detected using a small number of TFTs, and therefore, it is easy to correct the drain current values Iru and Irb detected by the current sensors 53ru and 53rb, or the drain current values Ifu and Ifb detected by the current sensors 53fu and 53fb. As a result, the manufacturing cost of the display panel 10 is low.

FIG. 11B is a diagram for describing a control circuit 50 and monitor circuits 35ru, 35rb, 35fu, and 35fb in a variation of the third embodiment. The variation of the third embodiment will be described, focusing on differences from the third embodiment described with reference to FIG. 8.

As shown in FIG. 11B, in the variation of the third embodiment, the current sensors 53ru and 53rb are removed, and resistors 57ru and 57rb are provided between the positive terminal of the direct-current power supply 54r and the switches 52ru and 52rb. As a result, when the switches 52ru and 52rb are on, the drain voltages of the TFTs 6ru and 6rb are input to the input units 75ru and 75rb, respectively. Similarly, the current sensors 53fu and 53fb are removed, and resistors 57fu and 57fb are provided between the positive terminal of the direct-current power supply 54r and the switches 52fu and 52fb. As a result, when the switches 52fu and 52fb are on, the drain voltages of the TFTs 6fu and 6fb are input to the input units 75fu and 75fb, respectively. Such a variation is similarly applicable to a fourth embodiment below.

### Fourth Embodiment

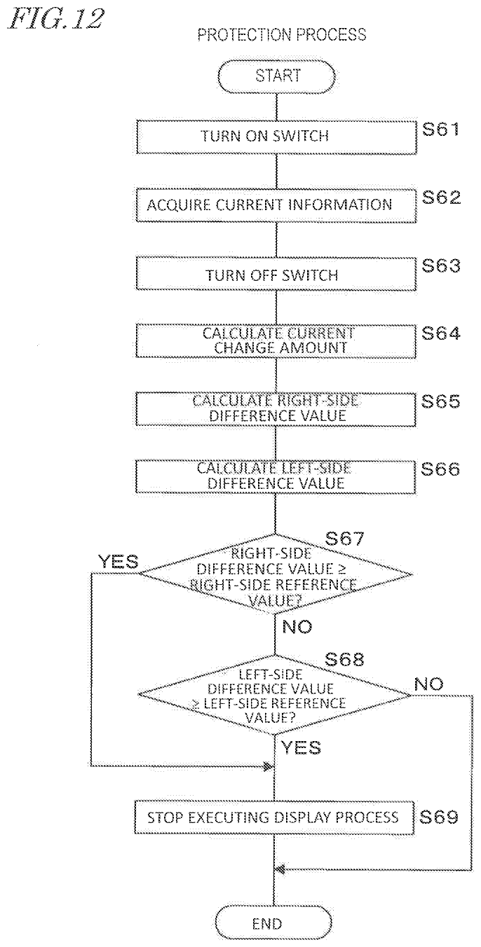

FIG. 12 is a flowchart showing steps of a protection process in a fourth embodiment.

Differences between the fourth embodiment and the third embodiment will now be described. Parts other than those described below are the as those of the third same embodiment, and therefore, parts common to the fourth and third embodiments are indicated by the same reference characters that are used in the third embodiment and will not be described.

A display apparatus 1 in the fourth embodiment is different from the display apparatus 1 in the third embodiment in the protection process executed by the control unit 70 of the control circuit 50 included in the display panel 10.

As in the third embodiment, the control unit 70 periodically executes the protection process in the fourth embodiment. Steps S61-S63 and S67-S69 of the protection process in the fourth embodiment are similar to steps S41-S43 and S47-S49 of the protection process in the third embodiment. Therefore, steps S61-S63 and S67-S69 will not be described in detail.

In the storage unit 71, set current values (also referred to as “characteristic values”) Ir1, Ir2, If1, and If2 are previously set in association with the plurality of TFTs 6ru, 6rb, 6fu, and 6fb, respectively. The set current value Ir1 is a drain current value Iru that occurs when the temperature of the TFT 6ru is a predetermined temperature. Similarly, the set current value Ir2 is a drain current value Irb that occurs when the temperature of the TFT 6rb is the predetermined temperature. The set current value If1 is a drain current value Ifu that occurs when the temperature of the TFT 6fu is the predetermined temperature. The set current value If2 is a drain current value Ifb that occurs when the temperature of the TFT 6fb is the predetermined temperature.

After executing step S63, the control unit 70 calculates current change amounts of the drain current values Iru, Irb, Ifu, and Ifb indicated by four pieces of current information acquired in step S62 from the set current values Ir1, Ir2, If1, and If2 that are previously set in association with the TFTs 6ru, 6rb, 6fu, and 6fb, respectively (step S64.

The current change amount of the drain current value Iru is calculated by subtracting the set current value Ir1 from the drain current value Iru, and indicates a temperature difference calculated by subtracting a predetermined temperature from the temperature of a portion where the TFT 6ru is located.

Similarly, the current change amount of the drain current value Irb is calculated by subtracting the set current value Ir2 from the drain current value Irb, and indicates a temperature difference calculated by subtracting the predetermined temperature from the temperature of a portion where the TFT 6rb is located. The current change amount of the drain current value Ifu is calculated by subtracting the set current value If1 from the drain current value Ifu, and indicates a temperature difference calculated by subtracting the predetermined temperature from the temperature of a portion where the TFT 6fu is located. The current change amount of the drain current value Ifb is calculated by subtracting the set current value If2 from the drain current value Ifb, and indicates a temperature difference calculated by subtracting the predetermined temperature from the temperature of a portion where the TFT 6fb is located.

Next, the control unit 70 calculates a right-side difference value that is a difference value between the current change amount of the drain current value Iru and the current change amount of the drain current value Irb (step S65). The right-side difference value is an absolute value. The right-side difference value indicates a temperature difference between a plurality of portions where the TFTs 6ru and 6rb are located in the display panel 10. The right-side difference value increases with an increase in the temperature difference. Therefore, by executing step S65, the control unit 70 can appropriately detect a temperature difference between a plurality of portions where the TFTs 6ru and 6rb are located. In addition, because the right-side difference value is a difference value between two current change amounts, even when there is a difference between the characteristics of the TFT 6ru and the characteristics of the TFT 6rb due to manufacturing variations, the control unit 70 can appropriately detect a temperature difference between the TFT 6ru and the TFT 6rb on the basis of the right-side difference value.

Next, the control unit 70 calculates a left-side difference value that is a difference value between the current change amount of the drain current value Ifu and the current change amount of the drain current value Ifb (step S66). The left-side difference value is an absolute value. The left-side difference value indicates a temperature difference between a plurality of portions where the TFTs 6fu and 6fb are located in the display panel 10. The left-side difference value increases with an increase in the temperature difference. Therefore, by executing step S66, the control unit 70 can appropriately detect a temperature difference between a plurality of portions where the TFTs 6fu and 6fb are located. In addition, because the left-side difference value is a difference value between two current change amounts, even when there is a difference between the characteristics of the TFT 6fu and the characteristics of the TFT 6fb due to manufacturing variations, the control unit 70 can appropriately detect a temperature difference between the TFT 6fu and the TFT 6fb on the basis of the left-side difference value. The control unit 70 executes step S67 after executing step S66.

The display panel 10 in the fourth embodiment has an effect similar to that of the display panel 10 in the third embodiment. Note that in the case where a difference from the set current value is used as in the fourth embodiment, the temperature increase can be detected using only one monitor circuit (monitor TFT).

### Fifth Embodiment

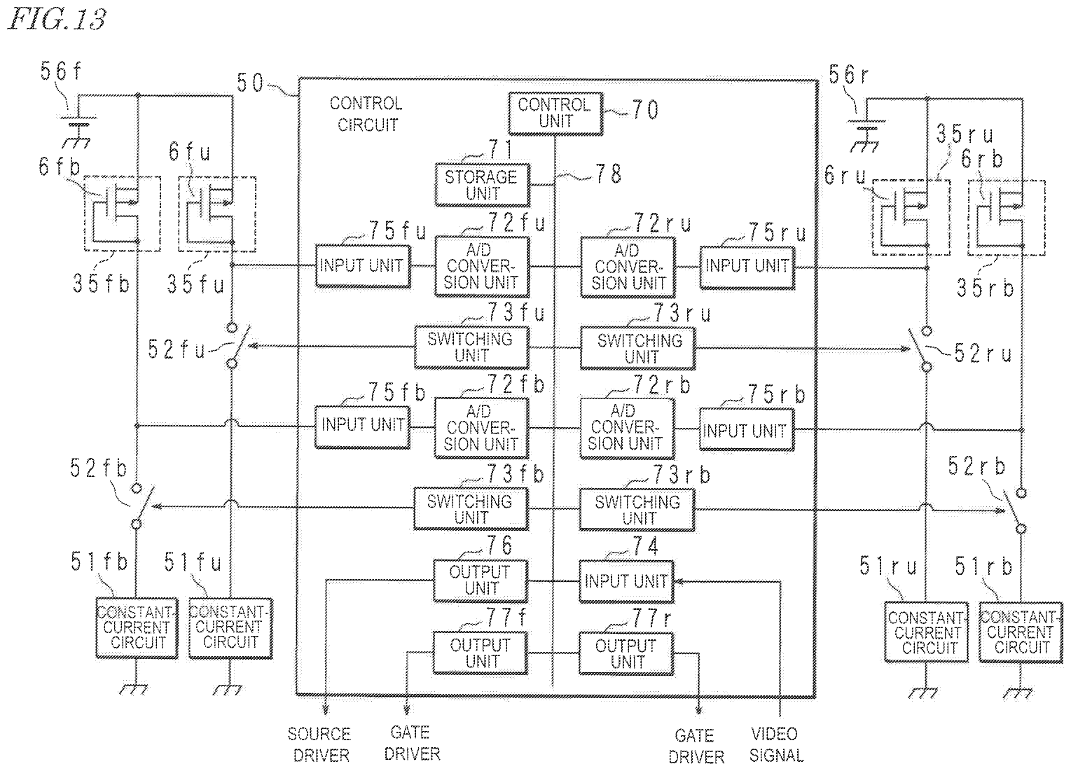

FIG. 13 is a diagram for describing a control circuit 50 and monitor circuits 35ru, 35rb, 35fu, and 35fb in a fifth embodiment.

Differences between the fifth embodiment and the first embodiment will now be described. Parts other than those described below are the same as those of the first embodiment, and therefore, parts common to the fifth and first embodiments are indicated by the same reference characters that are used in the first embodiment and will not be described.

A display panel 10 in the fifth embodiment has direct-current power supplies 56r and 56f in addition to the parts included in the display panel 10 in the first embodiment. In addition, each of the TFTs 6ru, 6rb, 6fu, and 6fb is of the P-channel type. The control circuit 50 has a configuration similar to that of the first embodiment.

The positive terminal of the direct-current power supply 56r is connected to the sources of the TFTs 6ru and 6rb. The negative terminal of the direct-current power supply 56r is grounded. In each of the TFTs 6ru and 6rb, the gate is connected to the drain. The TFTs 6ru, 6rb, 6fu, and 6fb are a so-called diode-connected TFT. The drain of the TFT 6ru, 6rb is connected to one end of the switch 52ru, 52rb, respectively. One end of the switch 52ru, 52rb is also connected to the input unit 75ru, 75rb, respectively, of the control circuit 50. The other end of the switch 52ru, 52rb is connected to the input end of the constant-current circuit. 51ru, 51rb, respectively. The output ends of the constant-current circuits 51ru and 51rb are grounded.

Similarly, the positive terminal of the direct-current power supply 56f is connected to the sources of the TFTs 6fu and 6fb. The negative terminal of the direct-current power supply 56f is grounded. In each of the TFTs 6fu and 6fb, the gate is connected to the drain. The drain of the TFT 6fu, 6fb is also connected to one end of the switch 52fu, 52fb, respectively. One end of the switch 52fu, 52fb is also connected to the input unit 75fu, 75fb, respectively, of the control circuit 50. The other end of the switch 52fu, 52fb is connected to the input end of the constant-current circuit 51fu, 51fb, respectively. The output ends of the constant-current circuits 51fu and 51fb are grounded.

In each of the TFTs 6ru, 6rb, 6fu, and 6fb, a current flows through the drain and the source. In each of the TFTs 6ru, 6rb, 6fu, and 6fb, the resistance value between the drain and the source decreases with a decrease in the gate voltage value relative to the potential of the source.

When the switch 52ru has been turned on by the switching unit 73ru, the constant-current circuit 51ru draws a current having a predetermined current value from the drain of the TFT 6ru through the switch 52ru. As a result, the gate voltage of the TFT 6ru settles to a certain value, so that the same current stably flows through the TFT 6ru and an interconnect (resistance). The gate voltage value is input to the input unit 75ru.

The input unit 75ru outputs the input analog gate voltage value to the A/D conversion unit 72ru. The A/D conversion unit 72ru converts the analog gate voltage value input from the input unit 75ru into a digital gate voltage value. The control unit 70 acquires the gate voltage value from the A/D conversion unit 72ru. The gate voltage value acquired by the A/D conversion unit 72ru is, at the time of the acquisition, substantially equal to the gate voltage value input to the input unit 75ru.

Note that the input of the gate voltage value to the input unit 75ru corresponds to the detection of the gate voltage value by the input unit 75ru.

When the switch 52ru has been turned off by the switching unit 73ru, a current does not flow through the TFT 6ru, and therefore, power is not consumed in the TFT 6ru.

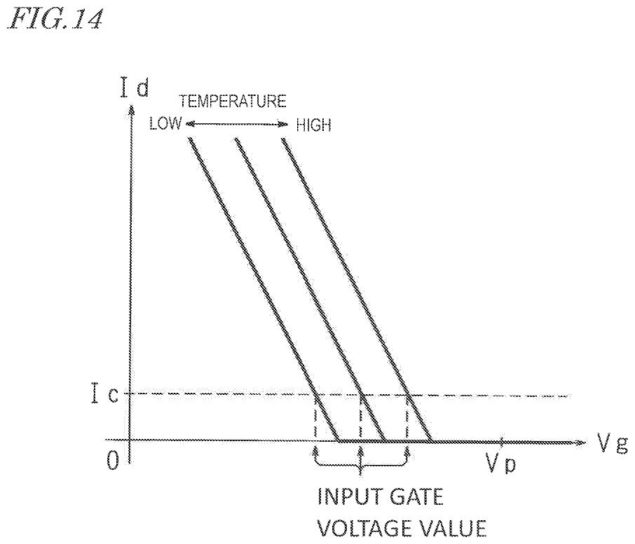

FIG. 14 is a diagram for describing a gate voltage value input to the control circuit 50. A gate voltage value input to the input unit 75ru of the control circuit 50 will be described, assuming that the switch 52ru is on.

FIG. 14 shows a relationship between a gate voltage value Vg and a drain current value Id that occur when the voltage value between the drain and source of the TFT 6ru is fixed to a predetermined voltage value. The gate voltage value Vg is a voltage value relative to a ground potential, and the drain current value Id is a current value of a current flowing through the drain and the source.

As shown in FIG. 14, when the gate voltage value Vg is lower than a voltage threshold that is lower than an output voltage value Vp of the direct-current power supply 56r, the drain current value Id is greater than zero. As the gate voltage value Vg decreases, the drain current value Id increases. The voltage threshold decreases with a decrease in the temperature of the TFT 6ru. A gate voltage value that occurs when the drain current value Id is equal to a predetermined current value Ic is input to the input unit 75ru of the control circuit 50. The gate voltage value input to the input unit 75ru decreases with a decrease in the temperature of the TFT 6ru.

The TFT 6rb, the constant-current circuit 51rb, the switch 52rb, the A/D conversion unit 72rb, and the switching unit 73rb operate similarly to the TFT 6ru, the constant-current circuit 51rb, the switch 52rb, the A/D conversion unit 72rb, and the switching unit 73rb.

In addition, the TFT 6fu, the constant-current circuit 51fu, the switch 52fu, the direct-current power supply 56f, the A/D conversion unit 72fu, and the switching unit 73fu operate similarly to the TFT 6ru, the constant-current circuit 51ru, the switch 52ru, the direct-current power supply 56r, the A/D conversion unit 72ru, and the switching unit 73ru. Furthermore, the TFT 6fb, the constant-current circuit 51fb, the switch 52fb, the direct-current power supply 56f, the A/D conversion unit 72fb, and the switching unit 73fb also operate similarly to the TFT 6ru, the constant-current circuit 51ru, the switch 52ru, the direct-current power supply 56r, the A/D conversion unit 72ru, and the switching unit 73ru.

As in the first embodiment, the control unit 70 executes a display process and a protection process.

The display panel 10 thus configured in the fifth embodiment has an effect similar to that of the display panel 10 in the first embodiment.

Note that in the fifth embodiment, the control unit 70 may execute a protection process similar to that of the second embodiment. In this case, the display panel 10 has an effect similar to that of the display panel 10 in the second embodiment.

### Sixth Embodiment

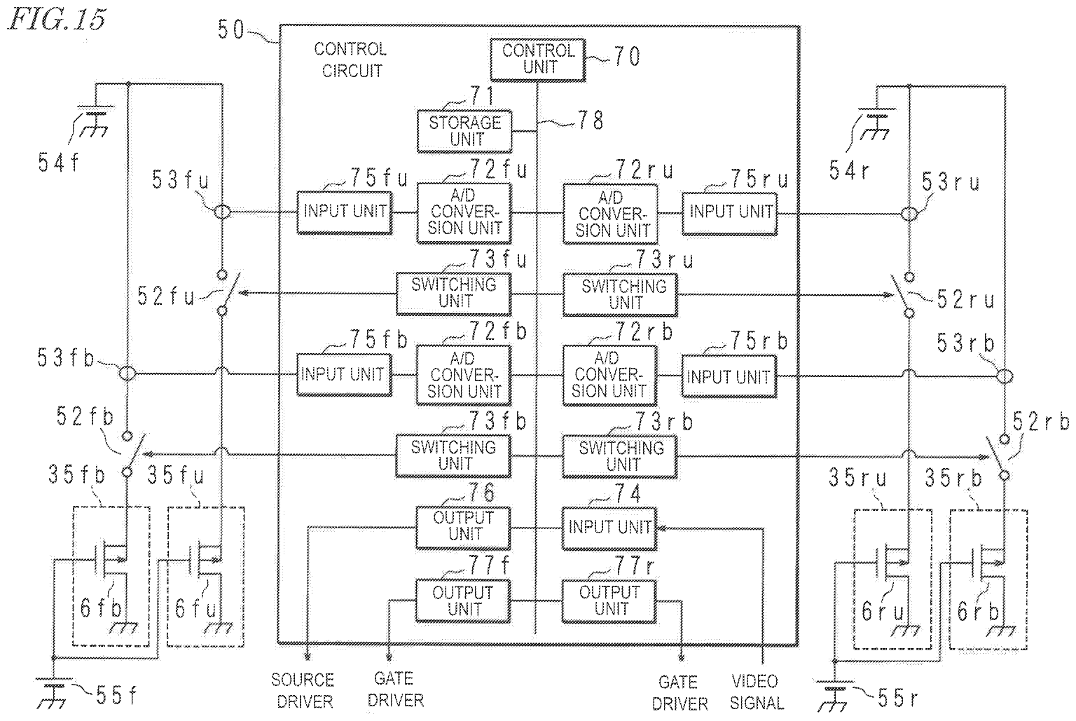

FIG. 15 is a diagram for describing a control circuit 50 and monitor circuits 35ru, 35rb, 35fu, and 35fb in a sixth embodiment.

Differences between the sixth embodiment and the third embodiment will now be described. Parts other than those described below are the same as those of the third embodiment, and therefore, parts common to the sixth and third embodiments are indicated by the same reference characters that are used in the third embodiment and will not be described.

A display panel 10 in the sixth embodiment is different from the display panel 10 in the third embodiment in that each of the TFTs 6ru, 6rb, 6fu, and 6fb is of the P-channel type. In the sixth embodiment, the source of the TFT 6ru, 6rb, 6fu, 6fb is connected to the other end of the switch 52ru, 52rb, 52fu, 52fb, respectively. The drains of the TFTs 6ru, 6rb, 6fu, and 6fb are each grounded.

In the sixth embodiment, the TFTs 6ru, 6rb, 6fu, and 6fb each operate similarly to the fifth embodiment. Therefore, in each of the TFTs 6ru, 6rb, 6fu, and 6fb, the resistance value between the drain and the source decreases with a decrease in the gate voltage value relative to the source potential.

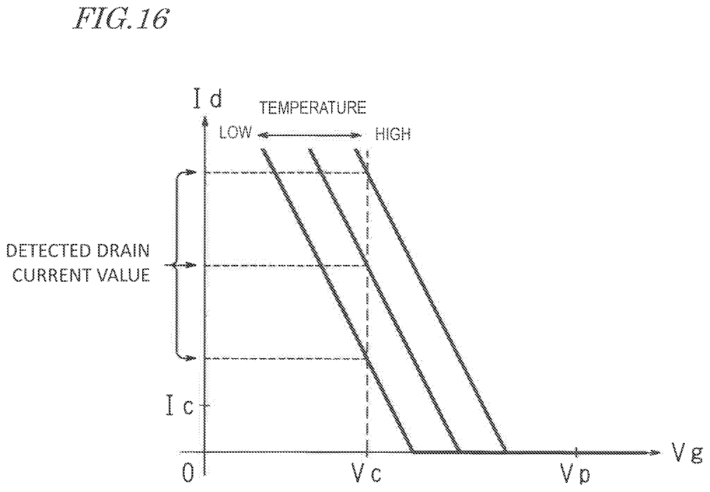

FIG. 16 is a diagram for describing a drain current value detected by the current sensor 53ru. The drain current value detected by the current sensor 53ru will be described, assuming that the switch 52ru is on.

As with FIG. 14, FIG. 16 shows a relationship between the gate voltage value Vg and the drain current value Id that occur when the voltage value between the drain and source of the TFT 6ru is fixed to a predetermined voltage value. The relationship the gate voltage value Vg and the drain current value Id of FIG. 16 is the same as that shown in FIG. 14.

The current sensor 53ru detects the drain current value Id that occurs when the gate voltage value Vg is equal to the output voltage value Vc of the direct-current power supply 55r. Therefore, the drain current value Id detected by current sensor 53ru decreases with a decrease in the temperature of the TFT 6ru.

Similarly, the drain current values Id detected by the current sensors 53rb, 53fu, and 53fb decrease with a decrease in the temperatures of the TFTs 6rb, 6fu, and 6fb, respectively.

The control unit 70 executes a display process and a protection process similar to those of the third embodiment.

The display panel 10 thus configured in the sixth embodiment has an effect similar to that of the display panel 10 in the third embodiment.

In addition, as in the third embodiment, the current sensors 53ru and 53rb may be removed, and resistors may be provided between the positive terminal of the direct-current power supply 54r and the switches 52ru and 52rb, and when the switches 52ru and 52rb are on, the source voltages of the TFTs 6ru and 6rb may be input to the input units 75ru and 75rb, respectively. Similarly, the current sensors 53fu and 53fb may be removed, and resistors may be provided between the positive terminal of the direct-current power supply 54r and the switches 52fu and 52fb, and when the switches 52fu and 52fb are on, the source voltages of the TFTs 6fu and 6fb may be input to the input units 75fu and 75fb, respectively.

Note that in the sixth embodiment, the control unit 70 may executes a protection process similar to that of the fourth embodiment. In this case, the display panel 10 has an effect similar to that of the display panel 10 of the fourth embodiment.

Note that in the first and fifth embodiments, the control unit 70 may subtract each of the four gate voltage values from the average value of the four gate voltage values, instead of calculating the right-side difference value and the left-side difference value. As a result, the calculated difference value (absolute value) indicates a temperature difference between the temperature of a portion where each TFT is located and the average temperature of the temperatures of four portions where four TFTs are located. In this case, one gate voltage value is used as a reference to correct the other gate voltage values. In the second and fifth embodiments, the control unit 70 may subtract each of the four voltage change amounts from the average value of the four voltage change amounts, instead of calculating the right-side difference value and the left-side difference value. As a result, the calculated difference value (absolute value) indicates a temperature difference between the temperature of a portion where each TFT is located and the average temperature of the temperatures of four portions where four TFTs are located.

In the fifth embodiment in which the above calculation is performed, the output voltage values of the direct-current power supplies 56r and 56f are substantially equal to each other. When the calculated difference value is greater than or equal to a predetermined value, the control unit 70 stops executing the display process or outputting a control signal to one of the gate drivers 34r and 34f.

In the third and sixth embodiments, the control unit 70 may subtract each of the four drain current values from the average value of the four drain current values, instead of calculating the right-side difference value and the left-side difference value. As a result, the calculated difference value (absolute value) indicates a temperature difference between the temperature of a portion where each TFT is located and the average temperature of the temperatures of four portions where four TFTs are located. In this case, one drain current value is used as a reference to correct the other drain current values. In the fourth and sixth embodiments, the control unit 70 may subtract each of the four current change amounts from the average value of the four current change amounts, instead of calculating the right-side difference value and the left-side difference value. As a result, the calculated difference value (absolute value) indicates a temperature difference between the temperature of a portion where each TFT is located and the average temperature of the temperatures of four portions where four TFTs are located.

In the third, fourth, and sixth embodiments in which the above calculation is performed, the output voltage values of the direct-current power supplies 54r and 54f are substantially equal to each other, and the output voltage values of the direct-current power supplies 55r and 55f are also substantially equal to each other. When the calculated difference value is greater than or equal to a predetermined value, the control unit 70 stops executing the display process or outputting a control signal to one of the gate drivers 34r and 34f.

Furthermore, in the first to sixth embodiments, the number of monitor circuits is not limited to four, and may be two, three, or five or more. The TFT included in the monitor circuit is formed using, for example, the same semiconductor film as that of the TFT included in the monolithic driver. The semiconductor film may be the same as that of the TFT provided for each pixel.

It should be understood that the first to sixth embodiments herein are illustrative in all respects and not restrictive. The scope of the invention is defined by the appended claims, and therefore, all changes that fall within metes and bounds of the claims, or equivalence of such metes and bounds thereof, are intended to be embraced by the claims.

This application is based on Japanese Patent Applications No. 2018-146956, filed on Aug. 3, 2018, the entire contents of which are hereby incorporated by reference.

What is claimed is:

1. A display panel having a display region, and a surrounding region surrounding the display region, the display panel comprising:
at least one driver integrally formed in the surrounding region;
a plurality of monitor TFTs formed near the at least one driver, and including a first TFT and a second TFT; and
a temperature difference detection circuit for detecting a difference between a temperature of the first TFT and a temperature of the second TFT, on the basis of a first gate voltage of the first TFT and a second gate voltage of the second TFT that occur when a predetermined current is supplied to a drain of each of the first and second TFTs.

2. The display panel of claim 1, wherein
the temperature difference detection circuit has
a circuit for calculating a difference between the first gate voltage and the second gate voltage, and
a circuit for comparing the difference with a predetermined reference value.

3. The display panel of claim 1, wherein
the temperature difference detection circuit has
a circuit for calculating a voltage difference evaluation value on the basis of the first gate voltage, the second gate voltage, and a characteristic difference value previously determined on the basis of a difference between a characteristic of the first TFT and a characteristic of the second TFT, and
a circuit for comparing the voltage difference evaluation value with a predetermined reference value.

4. The display panel of claim 1, wherein
the temperature difference detection circuit has
a circuit for calculating a voltage difference evaluation value on the basis of the first gate voltage, the second gate voltage, a first characteristic value previously determined on the basis of a characteristic of the first TFT, and a second characteristic value previously determined on the basis of a characteristic of the second TFT, and
a circuit for comparing the voltage difference evaluation value with a predetermined reference value.

5. The display panel of claim 1, wherein
the first and second TFTs are each a diode-connected TFT.

6. The display panel of claim 1, wherein
a direct-current voltage is supplied to a source of each of the first and second TFTs.

7. The display panel of claim 1, wherein
the at least one driver includes two drivers provided in regions facing each other with the display region interposed between the regions.

8. A display panel having a display region, and a surrounding region surrounding the display region, the display panel comprising:
at least one driver integrally formed in the surrounding region;
a plurality of monitor TFTs formed near the at least one driver, and including a first TFT and a second TFT; and
a temperature difference detection circuit for detecting a difference between a temperature of the first TFT and a temperature of the second TFT, on the basis of a first drain current of the first TFT and a second drain current of the second TFT that occur when a predetermined direct-current voltage is supplied to a gate of each of the first and second TFTs.

9. The display panel of claim 8, wherein
the temperature difference detection circuit has
a circuit for calculating a difference between the first drain current and the second drain current, and
a circuit for comparing the difference with a predetermined reference value.

10. The display panel of claim 8, wherein
the temperature difference detection circuit has
a circuit for calculating a current difference evaluation value on the basis of the first drain current, the second drain current, and a characteristic difference value previously determined on the basis of a difference between a characteristic of the first TFT and a characteristic of the second TFT, and
a circuit for comparing the current difference evaluation value with a predetermined reference value.

11. The display panel of claim 8, wherein
the temperature difference detection circuit has
a circuit for calculating a current difference evaluation value on the basis of the first drain current, the second drain current, a first characteristic value previously determined on the basis of a characteristic of the first TFT, and a second characteristic value previously determined on the basis of a characteristic of the second TFT, and
a circuit for comparing the current difference evaluation value with a predetermined reference value.

12. The display panel of claim 8, wherein
a direct-current voltage is supplied to a drain of each of the first and second TFTs.

13. The display panel of claim 8, further comprising:
a first current sensor for detecting the first drain current; and
a second current sensor for detecting the second drain current.

14. The display panel of claim 8, wherein
the at least one driver includes two drivers provided in regions facing each other with the display region interposed between the regions.

15. A method for driving the display panel of claim 1, comprising:
limiting drive of the at least one driver on the basis of an output result of the temperature difference detection circuit.

16. A method for driving the display panel of claim 8, comprising:
limiting drive of the at least one driver on the basis of an output result of the temperature difference detection circuit.
